(19) United States
(12) Patent Application Publication
(10) Pub. No.: US 2015/0185268 A1
(43) Pub. Date: Jul. 2, 2015

(54) Monitoring Device for Monitoring a Circuit

(71) Applicant: Rainer Falk, Poing (DE)

(72) Inventor: Rainer Falk, Poing (DE)

(21) Appl. No.: 14/583,690

(22) Filed: Dec. 27, 2014

(30) Foreign Application Priority Data
Dec. 27, 2013 (DE) 102013227165.4

(51) Int. Cl. G01R 31/00; G06F 21/55

(52) U.S. Cl. CPC G01R 31/00; G06F 21/55; G06F 2221/034

(57) ABSTRACT

A monitoring device for monitoring a circuit is provided. The circuit has a main functional unit to perform a main calculation. The monitoring device includes a calculation unit to perform a test calculation in parallel with the performance of the main calculation and to provide a result of the test calculation. The calculation unit is disposed on the circuit. The monitoring device also includes a checking unit to check the result of the test calculation in order to detect a malfunction of the test calculation, and a signal generation unit to generate a signal in response to the result of the check, and to forward the signal to the main functional unit.

This application claims the benefit of DE 10 2013 227 165.4, filed on Dec. 27, 2013, which is hereby incorporated by reference in its entirety.

### BACKGROUND

The present embodiments relate to a monitoring device for monitoring a circuit.

A security mechanism (e.g., a cryptographic encryption algorithm) that is performed on a circuit such as, for example, an integrated circuit may be attacked through intentional invocation of faults (e.g., fault injection attacks). Due to a specifically invoked faulty behavior of this type, information on the secret key used, for example, may be output, or a query concerning the permissibility of an action may be skipped.

Protective techniques using redundant calculations and error codes may be used to protect against such attacks. However, these techniques may require expensive implementations and special hardware or a multiple calculation in software (e.g., coded processing). Since an implementation specifically protected against malfunction is to be developed, a high implementation cost may be incurred.

“Watchdogs” are known for automatically forcing a restart (e.g., if a CPU or software locks up). Embedded controllers may, for example, have a watchdog. The executed software application, for example, resets the watchdog sufficiently often. If this does not happen (e.g., in the event of a lock-up or program crash), a reset is automatically triggered.

Special chip card CPUs (e.g., crypto-controllers) are known. However, the protective measures of a semiconductor IC of this type have special design and production methods and are therefore not transferable to general CPUs. Examples of this are disclosed in http://www.bitkom.org/files/documents/Vortrag_{—}4_Attacks_and_Countermeasures_on_Embedded_Systems_INFINEON.pdf. To protect against random and, for example, intentionally invoked faults (e.g., fault injection attacks), it is known to use a duplicated CPU (e.g., redundancy) and to check the results for consistency, and to protect the memory contents with error detection and error correction codes. Such attacks may be carried out relatively simply (e.g., by spikes on the supply voltage).

From U.S. Pat. No. 7,801,298 B2 and DE 10 2004 061 312 A1, it is known to calculate a cryptographic algorithm or calculation step in duplicate, according to two different masking algorithms, and compare the two results. Two different results, by adapting the masking of the first masking algorithm to the result of the second masking algorithm (e.g., two different types of masking), are to be provided. As a result, the cryptographic algorithm is to be implemented in duplicate, once according to the first masking algorithm and once according to the second masking algorithm.

EP 2 280 511 A1 describes a system in which checksums of the processed data are determined and verified in the calculation as a protective measure against fault attacks. It is disclosed in this connection to repeat or verify a cryptographic calculation.

In known systems, multi-channel computers with majority voting are used. In order to reduce the hardware cost, a “coded processing” in which a calculation is performed on an individual computer multiple times with differently coded values (e.g., inverted and non-inverted coding) is also known. This is disclosed, for example, in http://tudresden.de/die_tu_dresden/fakultaeten/fakultaet_informatik/sysa/se/research/projects/enc_proc and http://tudresden.de/die_tu_dresden/fakultaeten/fakultaet_informatik/sysa/se/research/projects/enc_proc/SIListraWhitepaper.pdf.

“Coded processing” is used, for example, in software-based security-critical automation control computers, as also disclosed in http://www.computerautomation.de/steuerungsebene/safety/fachwissen/article/74386/0/Safety_auf_dem_PC_-_per_Software-Controller/. “Coded processing” is a method that allows security-oriented applications to be implemented with one processor only. Program parts are first directly executed, then coded and executed again in coded form. The results of the different calculation processes are compared, and the program triggers a shutdown in the event of deviations. An additional dynamic monitoring controls the processing and implements the second shutdown process.

In the rail safety environment, a vital coded processor is used, as also described in http://se.inf.tudresden.de/pubs/papers/wappler2007indin.pdf. The following is used as a coding rule for a variable xc:=xf*A+Bx+D (see e.g., http://www.elektronikpraxis. vogel.de/themen/embeddedsoftwareengineering/analyseentwurf/articles/173862/index2.ht ml). A type of masking, where the value occurs in modified form, is thus implemented, and error detection code (e.g., bit errors) may be detected. A manipulation of the program control flow may also be detected. In this connection, a “Safety Code Weaving” is also described in which a calculation is performed once with uncoded variables and once with coded variables. Two redundant channels that are arithmetically coded with different prime numbers (e.g., both channels may operate in a coded manner) may also be implemented. A different coding is used for each channel. This is also disclosed in the dissertation by Ute Schiffel: Hardware Error Detection Using AN-Codes, TU Dresden, 2011, http://www.qucosa.de/fileadmin/data/qucosa/documents/6987/diss.pdf and http://www.dateconference.com/proceedings/PAPERS/2008/DATE08/PDFFILES/08.1_{—}3.PDF.

### SUMMARY AND DESCRIPTION

The scope of the present invention is defined solely by the appended claims and is not affected to any degree by the statements within this summary.

The present embodiments may obviate one or more of the drawbacks or limitations in the related art. For example, a simple and economical monitoring of circuits is provided.

A monitoring device for monitoring a circuit is provided. The circuit includes a main functional unit that performs a main calculation. The monitoring device includes a calculation unit to perform a test calculation in parallel with the performance of the main calculation and to provide a result of the test calculation. The calculation unit is disposed on the circuit. The monitoring device also includes a checking unit to check the result of the test calculation in order to detect a malfunction of the test calculation, and a signal generation unit to generate a signal in response to the result of the check and to forward the signal to the main functional unit.

Due to the disposition of the calculation unit on the same circuit as the main functional unit, the calculation unit is exposed to the same attacks as the main functional unit. In this way, attacks may be detected through a simple test calculation and the checking thereof, without having to elaborately monitor or check the main functional unit or a result. In contrast to known systems, the monitoring device does not monitor the main functional unit, but rather, a dedicated calculation unit, which serves as a test function. This may be designed more simply than the actual main functional unit.

The circuit may, for example, be a field programmable gate array (FPGA) or an application-specific integrated circuit (ASIC). A main function or main calculation (e.g., the actual function that is executed on the circuit) is performed in parallel with the test calculation. The test calculation responds to fault attacks or fault injection attacks in the same way as the main function, since the main function is disposed on the same circuit or chip. If a malfunction is detected in the test calculation, a probable attack may be inferred, and for example, an output of the result of the main function may be prevented.

The sometimes complex main function is not therefore implemented in a fault-protected manner, but rather, a separate test function is calculated in a fault-protected manner by the monitoring device or the calculation unit. This test calculation is performed only for the purpose of detecting a malfunction. Since a plurality of functions are calculated in parallel on an FPGA or ASIC, a fault attack will result with high probability not only in a miscalculation of the main function, but also in a miscalculation of the test function. For a successful fault injection attack on the main function, the attacker would have to invoke a fault in such a way that the main function has a specific fault behavior but the test function does not. Since both are executed simultaneously on the same hardware (e.g., circuit), a separate attack of this type is difficult to carry out. For example, attacks via external interfaces of a semiconductor IC (e.g., FPGA chip; without opening the chip) may hardly be carried out in such a way that only one individual targeted part reveals a malfunction.

The main function does not therefore have to be implemented as fault-tolerant or fault-detecting, but only a functionally very simple and therefore resource-saving implementable test circuit or test calculation of the monitoring device (e.g., a fault injection monitor). As a result, fewer resources than in the case of a redundant implementation of a complex main function, as is the case in known systems, are required.

The test calculation or the calculation unit that performs the test calculation may be used with different main functions (e.g., main calculations) or main functional units that perform the main functions. The monitoring device may be added to existing designs of different main functions. Random malfunctions of the main function are not detected or prevented by the monitoring device, as would be required in the case of safety-related main functions (e.g., functional safety). However, a malfunction caused in a targeted manner from outside (e.g., through operation in impermissible temperature ranges, radiation of the IC, or due to spikes in the supply voltage or invalid clock signals) may be detected with high reliability and at low cost. As described above, this results not only in a malfunction of the main function, but also in a malfunction of the test function or test calculation of the calculation unit. A simply implementable and resource-saving protection against simply performable fault attacks may therefore be provided by the monitoring device of one or more of the present embodiments.

According to one embodiment, the malfunction is based on an attack (e.g., a fault injection attack).

Not only the main functional unit, but also the calculation unit and other units that are disposed on the same circuit are affected by attacks from outside, such as, for example, fault injection attacks. A malfunction of the calculation unit or the test calculation may therefore be regarded as a potential attack on the main function.

According to a further embodiment, the signal generation unit is configured to generate the signal such that the signal has information to instigate an action of the main functional unit.

The signal may, for example, have control information that instigates a control of the main functional unit to perform actions. The signal may also be referred to as an alarm signal (e.g., fault injection alarm), since the signal gives an indication of a potential attack.

According to a further embodiment, the action includes an erasure of memory contents, deactivation of output interfaces, an initiation of a restart and/or a stopping of the main calculation of the main functional unit.

An output of an incorrectly determined result of the main calculation, by which a potential attacker may obtain information, may be prevented in this way. The further performance of the main calculation may also be stopped if a fault attack is detected.

According to a further embodiment, the calculation unit is configured to perform a calculation of a function with a known desired value in the test calculation. The checking unit is configured, for example, to compare the result of the test calculation with the known desired value.

According to this embodiment, the expected result is known. A comparison of the actual result with the expected result (e.g., the desired value) provides an indication of a potential attack in the event of a deviation. This is also referred to as a built-in test or known answer test.

According to a further embodiment, the calculation unit is configured to perform the test calculation multiple times. The checking unit is, for example, configured to compare the results of the multiple test calculation.

This may also be referred to as a redundant calculation. Multiple parallel or consecutively performed tests calculations may be provided. The respective result of this is checked for consistency. These may be calculated in an implementation with differently coded test data.

According to a further embodiment, the checking unit is configured to check the result of the test calculation using error detection codes.

In the case of error detection codes, code combinations may be generated according to special rules, so that a code combination that may be recognized as invalid occurs due to specific occurring faults. Checksums may also be generated and verified.

According to a further embodiment, the calculation unit is configured to perform the test calculation with coded data. The checking unit is, for example, configured to check the coded result.

In the case of coded processing, the calculation is performed with coded data, where faults in the data or in the program flow may be detected by the coded result value.

According to a further embodiment, the calculation unit has a counter (e.g., a cyclical counter).

A counter of this type has a plurality (e.g., at least two) of states. Switchover is effected between these states. In the case of a cyclical counter, for example, a switchover is effected from state Z0 to state Z1 and from state Z1 to state Z2. Switchover to state Z0 is then effected once more. In the event of an attack, for example, a state is skipped, so that this may be recognized as a malfunction.

According to a further embodiment, the counter is a state machine

The state machine or finite machine may, for example, be linked to a randomization. This provides that a randomization parameter that is randomly selectable is used by the test calculation. The randomization parameter may, for example, be linked to the state coding of the finite machine via an exclusive-or, additive, or multiplicative operation. A targeted fault attack is additionally impeded by the changing, outwardly unpredictable randomization.

According to a further embodiment, the signal generation unit is configured to transmit the signal with a time delay.

Due to the time-delayed forwarding, an action of the main functional unit is triggered with a delay for the detection of a malfunction. In this way, it may be made difficult for an attacker to recognize when an attack was successful.

According to a further embodiment, the calculation unit is configured as more susceptible to attacks than the main functional unit.

For this purpose, the calculation unit may, for example, be operated at a higher clock frequency than the main functional unit or the calculation unit may specifically have at least a critical timing path that is longer than the most critical path of the main functional unit. It may thereby be achieved that, under impermissible ambient conditions (e.g., an attack), a malfunction occurs earlier in the calculation unit than in the main functional unit.

In one embodiment, the monitoring device may be implemented on a system-on-chip component that has an FPGA module and a CPU module. The monitoring device is, for example, implemented on the FPGA module. If a malfunction is detected, a second function of the FPGA module may be blocked. This may involve, for example, a cryptographic operation. In one embodiment, the status of the monitoring device may be queried and, if necessary, reset by the CPU module (e.g., by software programs). In one embodiment, an interrupt or reset of the CPU may be triggered if a fault is detected. A restart may thus be forced, or a software routine may be activated to handle the fault condition.

According to a further aspect, a circuit with a main functional unit that performs the main calculation, and a monitoring device, as explained above, to monitor the circuit is provided.

A circuit of this type may, for example, be an integrated circuit. Such circuits include, for example, field programmable gate arrays (FPGAs) and application-specific integrated circuits (ASICs).

According to a further aspect, a method for monitoring a circuit is provided. The circuit includes a main functional unit that performs a main calculation. The method includes calculating a test calculation in a calculation unit in parallel with the main calculation. The calculation unit is disposed on the circuit. The method also includes providing a result of the test calculation, checking the result of the test calculation in order to detect a malfunction of the test calculation, generating a signal in response to the result of the check, and forwarding the signal to the main functional unit.

A computer program product that instigates the performance of the method explained above on a program-controlled device is provided.

A computer program product such as, for example, a computer program device may be provided or supplied, for example, as a storage medium (e.g., a non-transitory computer-readable storage medium such as a memory card, USB stick, CD-ROM, DVD) or in the form of a downloadable file from a server in a network. This may be effected, for example, in a wireless communication network through the transmission of a corresponding file with the computer program product or the computer program device.

The embodiments and features described for the proposed device apply accordingly to the proposed method.

Further possible implementations also include combinations, not explicitly specified, of features or embodiments described above or below in relation to the example embodiments. The person skilled in the art will also add individual aspects as improvements or supplements to the respective basic form of the invention.

### BRIEF DESCRIPTION OF THE DRAWINGS

FIG. 1 shows a schematic block diagram of one embodiment of a circuit with a monitoring device and a main functional unit;

FIG. 2 shows a schematic block diagram of one embodiment of a cyclical counter of a monitoring device;

FIG. 3 shows a schematic block diagram of one embodiment of a state machine for the cyclical counter shown in FIG. 2; and

FIG. 4 shows a flow diagram of an example embodiment of a method for monitoring a circuit.

### DETAILED DESCRIPTION

In the figures, same or functionally same elements are denoted by the same reference numbers, unless otherwise indicated.

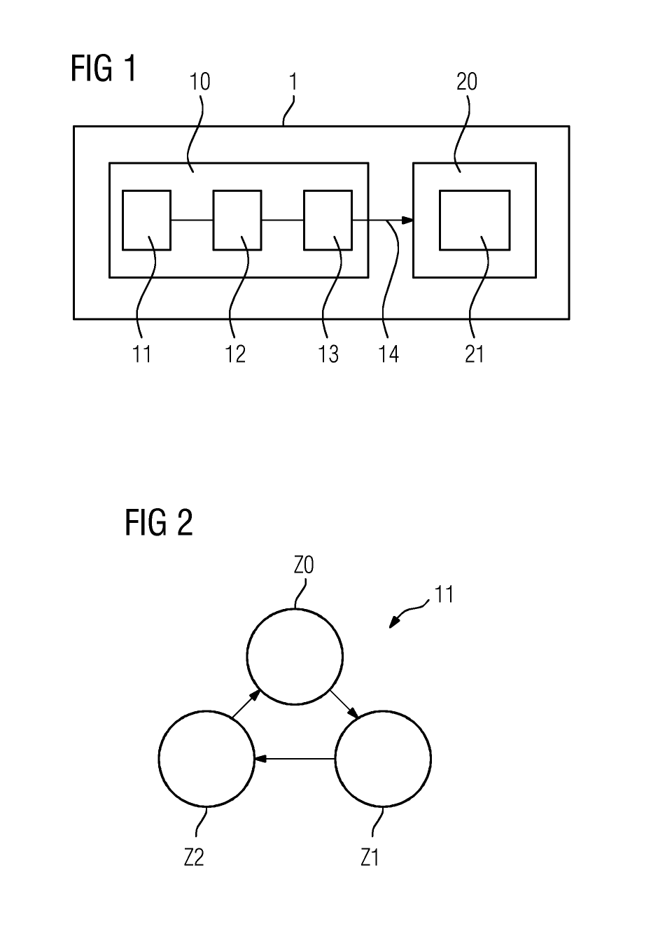

FIG. 1 shows one embodiment of a circuit 1 that includes a monitoring device 10 for monitoring the circuit 1 and a main functional unit 20.

The main functional unit 20 performs a main calculation. A monitoring device 10 is provided in order to detect an attack on the circuit 1 or the main functional unit 20 on the circuit 1. The monitoring device 10 serves to detect, for example, fault injection attacks and to prevent a function, such as, for example, an output of a result of the main functional unit 20, or to cause a function, such as a restart, of the main functional unit.

The monitoring device 10 includes a calculation unit 11 that carries out a test calculation in parallel with the performance of the main calculation. If the circuit 1 is attacked, the test calculation is affected in the same way as the main calculation and will therefore similarly deliver a faulty result. Although all units of the monitoring device 10 are disposed on the circuit 1 in FIG. 1, only the calculation unit 11 may be disposed on the circuit in order to be exposed to the same attacks as the main functional unit.

The result of the test calculation is supplied to a checking unit 12 that checks this result in order to detect a malfunction in the test calculation. If the result is classified as faulty, a signal 14 (e.g., a fault injection (FI) alarm) is generated in a signal generation unit 13 and forwarded to the main functional unit 20.

The main functional unit 20 may then perform a function, for example via a controller 21. Such functions include, for example, a restart of the main calculation, a non-dispatch of the result, a transmission of a dummy signal, or the like. The aim is to not supply any relevant information on the main calculation to a potential attacker. The controller may be a digital circuit (e.g., an input/output unit) that deactivates the interface, or a CPU that, for example, may trigger an interrupt so that a fault handling routine is called.

As shown in FIG. 2, the calculation unit 11 may, for example, be a counter with redundant coding of the counter states. The counter may be present in multiple forms. A comparison (e.g., monitoring) for correctness of the counter value and, if necessary, for consistency of the counter values may be carried out. A possible implementation of a counter is a cyclical counter, as shown in FIG. 2. The counter counts Z0→Z1→Z2→Z0 and so on.

The coding for the states Z0, Z1, Z2 may be selected, for example, as follows:
Z0: 0110 1101
Z1: 1011 1011
Z2: 0010 0101

In one implementation, the states are randomized depending on a randomization parameter r changing for the execution. To do this, the parameter r may be determined by a random number generator (e.g., with each system start or at regular time intervals). A state Zi is then randomized and coded as Zi‘:=Zi XOR r.

The values for Z0, Z1, Z2 may be determined randomly (e.g., during the development) or may be determined as design parameters according to a deterministic calculation function. In the case of a deterministic calculation function, the values may be determined, for example, as a hash value of the character strings Z0, Z1, Z2. The individual bits may be determined as check bits (e.g., parity bit or CRC checksum).

Functions for calculating the subsequent state based on the current state are then formed in the cyclical counter. These functions are constructed such that a value differing in one or more bits results in an invalid value. Thus, the expected value of 4 or 6 bits of the current state may be checked, for example, for each bit of the subsequent state.

In the case of the counter shown in FIG. 2, the counter states Z0, Z1, Z2 are coded as an 8-bit data word. Randomly selected bit values, for example, may be chosen for this purpose.

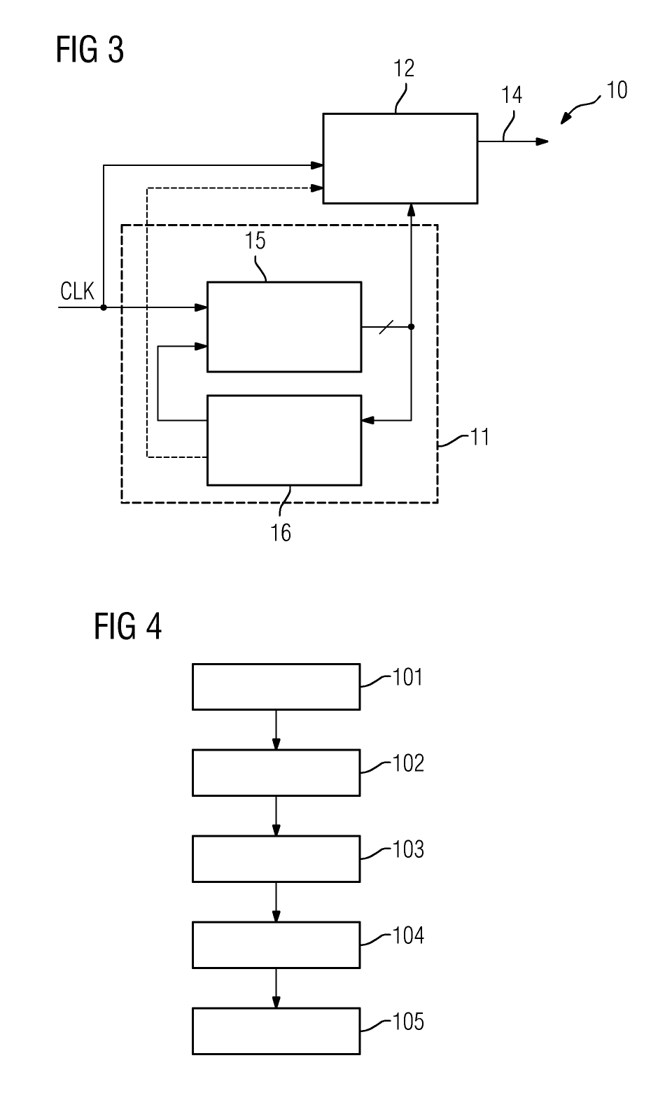

A state machine for the cyclical counter from FIG. 2 is shown in FIG. 3. In the case of a state transition, the subsequent value is calculated by the state transition function 16 as a logical operation depending on the current state. This may be done, for example, by an Exclusive-Or operation of the current value in the state register 15 with a fixed value. More complex logical functions may also be implemented (e.g., using And, Or and negation operations). For example, delays may be intentionally built in through functionally redundant logic elements such as a chain of inverters in order to design the monitoring device 10 and the calculation unit 11 intentionally time-critically (e.g., more slowly than the main functional unit 20).

If a fault attack is then carried out, this may result in a bit error or in a skipping of a state. As a result, an invalid value may appear in the state register 15. A state verifier representing the checking unit 12 then checks whether the value in the state register 15 is one of the valid values (e.g., three valid values). In the event of a deviation, an FI alarm signal 14 is provided. As soon as an invalid state has been detected, the information may be stored. This may be done, for example, redundantly. In one variant, the fault memory is resettable. In one variant, which is shown by a broken line in FIG. 3, the checking unit 12 checks not only the value of the state register 15, but also the value of the subsequent state determined by the state transition function 16.

In one embodiment, the counter block may be provided in duplicate or n-fold. The state verifier 12 may then also check the values of the plurality of counters Z0, Z1, Z2. Each counter value may be checked individually to determine whether the counter value is a permissible counter value. However, the consistency of the counter values with one another may also be checked. In the simplest case, an identity check is carried out for this purpose. However, the counter values may be differently coded, and the counters Z0, Z1, Z2 may have number ranges of different sizes. A consistency check of the different counters Z0, Z1, Z2 may then be carried out.

The counters Z0, Z1, Z2 may, for example, be constructed such that the counters have critical paths of different lengths. One counter Z0, Z1, Z2 may have a longer critical path than the main calculation of the main functional unit 20, while another counter Z0, Z1, Z2 may have a shorter critical path than the monitored main calculation of the main functional unit 20. It may thereby be recognized if a clock cycle is too short (e.g., resulting in a skipping of a state transition in the case of the slower counter Z0, Z1, Z2). The faster counter, which still functions correctly even at higher clock frequencies defined by the clock CLK, would be one counter value further. The two inconsistent counter values may be identified as faults.

In one variant, a clock signal CLK of the circuit or chip 1 is not used. Instead, the monitoring device 10 includes a clock generator that may be implemented, for example, as a feedback ring oscillator.

FIG. 4 shows one embodiment of a method for monitoring a circuit 1. As shown, for example, in FIG. 1, the circuit 1 includes a main functional unit 20 that performs a main calculation.

In act 101, a test calculation is performed in a calculation unit 11 in parallel with the performance of the main calculation. As shown in FIG. 1, the calculation unit 11 is disposed on the circuit 1.

In act 102, a result of the test calculation is provided.

In act 103, the result of the test calculation is checked in order to detect a malfunction of the test calculation.

In act 104, a signal 14 is generated in response to the result of the check and is forwarded in act 105 to the main functional unit 20.

Although the present invention has been described based on example embodiments, the present invention is modifiable in a variety of ways.

It is to be understood that the elements and features recited in the appended claims may be combined in different ways to produce new claims that likewise fall within the scope of the present invention. Thus, whereas the dependent claims appended below depend from only a single independent or dependent claim, it is to be understood that these dependent claims can, alternatively, be made to depend in the alternative from any preceding or following claim, whether independent or dependent, and that such new combinations are to be understood as forming a part of the present specification.

While the present invention has been described above by reference to various embodiments, it should be understood that many changes and modifications can be made to the described embodiments. It is therefore intended that the foregoing description be regarded as illustrative rather than limiting, and that it be understood that all equivalents and/or combinations of embodiments are intended to be included in this description.

1. A monitoring device for monitoring a circuit, wherein the circuit comprises a main functional unit to perform a main calculation, the monitoring device comprising:
a calculation unit configured to:
perform a separate test calculation in parallel with the performance of the main calculation; and
provide a result of the separate test calculation, wherein the calculation unit is disposed on the circuit and is configured as functionally simpler than the main functional unit;
a checking unit configured to check the result of the separate test calculation in order to detect a malfunction of the separate test calculation; and
a signal generation unit configured to:
generate a signal in response to the result of the check; and
forward the signal to the main functional unit.

2. The monitoring device of claim 1, wherein the malfunction is based on an attack on the circuit.

3. The monitoring device of claim 2, wherein the attack is a fault injection attack.

4. The monitoring device of claim 1, wherein the signal generation unit is configured to generate the signal such that the signal has information to instigate an action of the main functional unit.

5. The monitoring device of claim 4, wherein the action comprises an erasure of memory contents, a deactivation of output interfaces, an initiation of a restart, a stopping of the main calculation of the main functional unit, or any combination thereof.

6. The monitoring of claim 1, wherein the calculation unit is configured to calculate a function with a known desired value in the separate test calculation, and
wherein the checking unit is configured to compare the result of the separate test calculation with the known desired value.

7. The monitoring device of claim 1, wherein the calculation unit is configured to perform the separate test calculation multiple times, and
wherein the checking unit is configured to compare the results of the separate test calculations.

8. The monitoring device of claim 1, wherein the checking unit is configured to check the result of the test calculation using error detection codes.

9. The monitoring device of claim 1, wherein the calculation unit is configured to perform the separate test calculation with coded data, and
wherein the checking unit is configured to check the coded result.

10. The monitoring device of claim 1, wherein the calculation unit comprises a counter.

11. The monitoring device of claim 10, wherein the counter comprises a cyclical counter.

12. The monitoring device of claim 10, wherein the counter is a state machine.

13. The monitoring device of claim 1, wherein the signal generation unit is configured to forward the generated signal with a time delay to the main functional unit.

14. The monitoring device of claim 1, wherein the calculation unit is configured such that the calculation unit is less susceptible to attacks than the main functional unit.

15. A circuit comprising:
a main functional unit configured to perform a main calculation; and
a monitoring device configured to monitor the circuit, the monitoring device comprising:
a calculation unit configured to:
perform a separate test calculation in parallel with the performance of the main calculation; and
provide a result of the separate test calculation, wherein the calculation unit is disposed on the circuit and is configured as functionally simpler than the main functional unit;
a checking unit configured to check the result of the separate test calculation in order to detect a malfunction of the separate test calculation; and
a signal generation unit configured to:
generate a signal in response to the result of the check; and
forward the signal to the main functional unit.

16. A method for monitoring a circuit, wherein the circuit comprises a main functional unit to perform a main calculation, the method comprising:
performing a separate test calculation in a calculation unit in parallel with the performance of the main calculation, wherein the calculation unit is disposed on the circuit and is configured as functionally simpler than the main functional unit;
providing a result of the separate test calculation;
checking the result of the separate test calculation in order to detect a malfunction of the separate test calculation;
generating a signal in response to the result of the checking; and
forwarding the signal to the main functional unit.

17. A computer program product comprising a non-transitory computer-readable storage medium having instructions executable by a program-controlled device to monitor a circuit, wherein the circuit comprises a main functional unit to perform a main calculation, the instructions comprising:
performing a separate test calculation in a calculation unit in parallel with the performance of the main calculation, wherein the calculation unit is disposed on the circuit and is configured as functionally simpler than the main functional unit;
providing a result of the separate test calculation;
checking the result of the separate test calculation in order to detect a malfunction of the separate test calculation;
generating a signal in response to the result of the checking; and
forwarding the signal to the main functional unit.
